(19) United States
(12) Patent Application Publication
(10) Pub. No.: US 2021/0396140 A1
(43) Pub. Date: Dec. 23, 2021

(54) METHOD FOR DESIGNING, CONSTRUCTING AND PRODUCING A TURBINE-IMPELLER-REACTOR WHEEL

(71) Applicant: Carpyz SAS, Issy les Moulineaux (FR)

(72) Inventor: Pierre CARROUSET, Paris (FR)

(21) Appl. No.: 17/044,877

(22) PCT Filed: Mar. 25, 2019
(86) PCT No.: PCT/EP2019/057454

§ 371 Date: Oct. 2, 2020

(30) Foreign Application Priority Data
Apr. 3, 2018 (LU) 100758

(51) Int. Cl. F01D 5/02

(52) U.S. Cl. CPC F01D 5/02; F05D 2230/20

(57) ABSTRACT

A method for designing, constructing and fabricating the skeleton of turbine-propeller-jet (THR) wheels which simultaneously use, in the same wheel, the principles of the turbine, the propeller, and the jet, and which can also serves as a hybrid wheel (THRE) powered by an energising fluid.

### TECHNICAL FIELD

The present invention relates to a method for designing, constructing and fabricating a turbine-propeller-jet (THR) wheel. More particularly, the present invention relates to a method for designing, constructing and fabricating hybrid turbine-propeller wheels.

### PRIOR ART

Improving the axial thrust of propellers has been sought for a long time and recent requests for the issuance of patents in France, in particular those published under FR 2 987 655 of 9 Jun. 2013, and FR 2 987 656 of 9 Jun. 2013. These known methods for designing and fabricating turbines integrated in the vanes of helical propellers make it possible to obtain, at equivalent diameters, greater axial thrusts than the propellers alone by means of thrusters which have turbines integrated in the vanes of the propellers. The construction is carried out starting from two blades which, by twisting, form the duct of the turbine integrated in the propeller vane. By combining the advantages of a turbine with those of an propeller, this type of propulsive unit makes it possible to obtain, for the same diameter, greater axial thrusts than those obtained with propellers alone.

The publication WO/2016/110364 describes a known method for designing and constructing wheels which are simultaneously: a turbine-propeller with vanes hollowed along their entire length that open into peripheral circular chambers which have a powered jet (THRA) function, this method making it possible, for each turbine-propeller-jet assembly (THRA), to construct with blades the scalable section of the internal duct of the blades, propellers which are hollow along their entire length, and are supported on the profiles of the neutral fibres of the blades which are mainly portions of circles, and which are constructed for the turbine inlet and for the hollowed propeller vane inlets and where they reach their chambers, and are individually configured by giving initial values to the basic geometric elements, and are drawn according to particular geometric arrangements, on circular plates with various diameters, which are then arranged at a plurality of levels on the wheel and are positioned angularly on the same axis independently from one another.

According to this method, the particular arrangement of the basic geometric elements applied to each circular plate is obtained by being inscribed in a circle, the centre of which, from which a spoke of a given numerical value starts which joins its circle at a preferred point of intersection, the circle being the surface of revolution swept by the leading edge of the blade during the rotation of the wheel. Another numerical value is given to the chord of the arc which is the portion of circle of the neutral fibre of the sought blade. One of the ends of this chord starts from the preferred point of intersection and the other is positioned inside the circle on an axis which starts from the preferred point and forms an angle of 45° with the spoke.

The position chosen for this axis to the right or left of the spoke determines the direction of rotation of the sought wheel which is placed on the spoke towards the centre, another point situated at a numerical value which is that of the radius of the circle which surrounds the wheel diminished by a numerical value which is the square root of the sum of the square of two ½ chords (Pythagoras), and a straight line of numerical value identical to that of the chord is drawn from the point and merges at its middle with the middle of the chord with which it is perpendicular and generates a point at its other end. The point located on the spoke serves as a centre with a numerical value equal to that of the straight line for the portion of the circle that joins the two ends of the chord which is its arc and which is the circular profile of the sought blade, and the point located at the other end of the line which cuts at its middle the chord serves as a centre to draw the portion of circle that joins the two ends of the chord which is also its arc and which is the other symmetrical circular profile of the sought blade,

Other centres of circles located on the perpendicular line, which use larger or smaller diameter values than such points, optionally allow them to join the ends of the line, and to generate portions of circles that have flatter or more curved profiles but that might also benefit from the method.

The profiles constructed with this method and with the same numerical values on each side of the spoke are symmetrical, and the mixing of the profiles of the blades obtained with this method makes it possible, by playing with the parameters, to construct scalable blades which have particular features, the numerical values of the profiles of the neutral fibres constructed according to this method being mathematically quantifiable, and the same wheel being able to use different turbine blade profiles and hollow propeller vane profiles which are defined with the same method but with different profiles on the same wheel.

The publication WO2008/012425 describes the “CARPYZ” principle known as the five-parameter principle and relates to a method for configuring elements that constitute hollow helical wheels or the cages thereof, which is based on the use of geometric figures, the centres of which serve as a reference for constructing them and defining their areas, the values of angles, centre offsets and pitches making it possible to control the constituent elements.

The publication WO2008/012425 (PCT/2007/011267) describes in detail the so-called five-parameter arithmetic principle, known to a person skilled in the art who keeps up with global technical innovations, who is therefore immediately informed by this publication WO2008/012425, if not already fully informed of this principle.

The so-called five-parameter principle makes it possible to fabricate a double-sided blade by simultaneously using only a choice of five numerical values, namely numerical values for 1) the leading edge, 2) the trailing edge, 3) the body, 4) the length, and 5) the camber, respectively.

The description of this patent application requires the reader to have sufficient knowledge of the latest modem CAD/CAM tools and the use of very powerful mathematical parametrisation tools such as Pro Engineer Creo and Dassault Systemes Catia, for example, or even other programming tools. It is necessary to use a little imagination, which is necessary as long as you have not held concrete parts in your hands. These wheels can only be fabricated layer by layer by additive manufacturing machines that receive the files generated by the specific ‘CARPYZ’ software packages directly via the internet from all over the world. Therefore, no numerical values are provided to the elements of the wheels. They know no limits, only prohibitions and incompatibilities issued in the course of use by the aforementioned tools. This present invention allows the complete SKELETON of the one-piece ‘CARPYZ’ wheel to be built progressively part by part.

The so-called five-parameter industrial computer tool makes it possible to easily generate, on demand and infinitely, helical blades of very complex shapes and provides the computer files for building same. A person skilled in the art must provide all the numerical values necessary for the so-called “five-parameter” principle for each element described independently. A person skilled in the art is able to associate the elements with one another as described. This so-called “five-parameter” principle is a rare industrial IT tool that discloses a calculation principle without numerical references.

### SUMMARY OF THE INVENTION

With a view to improving axial thrust, it is therefore clear that there is a need for a method for designing and fabricating a wheel which, to a large extent, overcomes the shortcomings that have been encountered in the prior art. One aim of the invention is to provide a method which makes it possible to significantly increase the axial thrust of the propellers, and which can be increased very significantly by an energising fluid.

This novel patent application does away with this method by employing everywhere the aforementioned CARPYZ principle known as the five-parameter principle which allows in a novel way a more methodical construction of all the constituent elements of CARPYZ THRA/E wheels.

The so-called five-parameter principle makes it possible to fabricate a double-sided blade by simultaneously using only a choice of five numerical values, namely numerical values for 1) the leading edge, 2) the trailing edge, 3) the body, 4) the length, and 5) the camber, respectively. The CARPYZ industrial computer tool makes it possible to easily generate, on demand and infinitely, helical blades of very complex shapes and provides the computer files for building same.

By following step-by-step what is described in the application, a person skilled in the art can concretely produce on the screen the turbines of their choice, as the applicant does, and provide files which allow them to be built physically by additive manufacturing all over the world.

A person skilled in the art must provide all the numerical values necessary for the so-called “five-parameter” principle for each element described independently in the patent application. A person skilled in the art is able to associate the elements with one another as described in the application.

This novel patent application does away with this method by employing everywhere the aforementioned CARPYZ principle known as the five-parameter principle which allows in a novel way a more methodical construction of all the constituent elements of CARPYZ THRA/E wheels of the invention.

According to the invention, “the so-called five-parameter arithmetic principle” is used. This feature refers to the industrial computer tool for computer-aided design and manufacturing, which was developed by the applicant of the present application. However, this precise principle is universally accepted and defines a standard principle or procedure that is accepted internationally as a particular sequence of standard operations.

For this purpose, the method for designing, constructing and fabricating a turbine-propeller-jet (THR) wheel of the invention is characterised by the fact that the skeleton of the one-piece wheel is constructed between three washers (FIG. 3, R1-R2-R3) using a specific CARPYZ software package that provides a basic image (FIG. 5) where all the constituent elements of the wheel are cited with numerical and arithmetic values that are provided by default in a non-exhaustive manner by using the “CARPYZ” principle known as the five-parameter principle.

This image is created in an arbitrary manner by CARPYZ on three areas of the wheel, the front of which is symbolically attached to the left as in the drawing (FIG. 3, AV) or according to (FIG. 5) is the fluid inlet, on the (FIG. 5, 2) is located the propeller, the (FIG. 5, 3) is located a chamber which acts under the wheel, by means of peripheral circular slots, hidden below in the drawing, like a jet.

With the image displayed on the screen, values determined intuitively are provided, according to the wheels already produced but which can be scaled infinitely according to the expected use of the designed wheel (for example: diameters, number of vanes, shape of the vanes, profile of the chambers, etc.). These values continuously use the CARPYZ principle known as the five-parameter principle (FIG. 1) (Patent FR2007/0011267). This makes it possible to easily combine curves together as desired by superimposing the centres thereof.

This basic image shows the blades of the first area (FIG. 5, 1) which, like an inductor, promotes the penetration of the fluid into the inlet of the hollow vanes of the propeller (FIG. 4, A R2). The profile of these blades is designed on the rear face of a first washer placed in front of the wheel (FIG. 3, R1), the diameters of which are provided by default, positioned on the axis in front of the wheel (FIG. 4, R1 and FIG. 2, R1).

With the wheel viewed from the front as in the drawing (FIG. 4) and rotating to the right in a clockwise direction (FIG. 4, Rot), the front edge of the blade is placed to the left on the large diameter of the washer, and the rear edge of the blade is placed to the right on the small diameter of the washer and is angularly offset towards the rear.

The values of the angular offset between the front and rear edges of the blade and the camber thereof are values provided by default with the five parameters and are corrected on demand by the designer of the wheel. Another blade profile similar to the previous one is also projected with the five parameters (shown in FIG. 4, three times on R2) on the front face of the second washer (FIG. 4, R2 A) which shows the pressure side (FIG. 4, R2 Int) and the suction side (FIG. 4, R2 Ext) of the inlet of the vane.

The blade is generated by the computer between the profiles of the two washers with the five parameters. Values are provided for the distance that separates the two washers and for the angular offset between the two washers which makes it possible to twist the blades, positively or negatively, are provided by default and are corrected by the designer. The blades are then said to be neutral, or moving downstream or being withdrawn.

The large profile of the intake blade is connected to and preferably merges with that of the suction side (FIG. 4, R2 Ext) of the inlet of the propeller vane which is also subject to the five parameters. The wheel is rotated by a shaft secured to the centre at the rear of the wheel, and rotates in the chosen direction of rotation which is reversible (FIG. 4, Rot). This first resolution shows how the front of the wheel is constructed, which is inseparable from the rear of the wheel, which is preferably in one piece. (FIG. 5, 1-2-3).

In a preferred embodiment of the invention, on the rear face of the second washer is positioned the inlet of the hollow vanes of the propeller which constitute the second area (FIG. 5, 2) of the wheel. The blades of the first area are brought into line with the blades of the suction side (FIG. 4, R2 Ext) of the vanes (FIG. 4, A) which are also adapted to the five parameters. The fluid inlet is located on the small diameter of the vanes and the fluid outlet is located on the large diameter of the vanes. In patent application FR 1500031 of 9 Jan. 2015 the inlet of the vanes is not constructed using the five parameters.

The vanes consist of two blades and open at their large diameter into a circular chamber located at the rear, which is the third area (FIG. 5, 3). The suction side blade (FIG. 4, R2 Ext) of the vane is convex at the inlet of the vane and at the outlet of the vane (FIG. 4, R3 A). The pressure side blade (FIG. 4, R2 Int) of the vane is concave at the inlet of the vane and convex at the outlet of the vane (FIG. 4, R3 Int).

In a preferred embodiment of the invention, the vanes of the propeller open onto the front face of the third washer (FIG. 3, R3) through which they pass. The right edge of the vane (FIG. 4, R3 A, B C, D) is placed on the large diameter of the washer. The left edge of the vane (FIG. 4, R3 A, C, D) is placed on the small diameter of the washer. The length of the vanes is provided by the angular portion of the washers in which they fit. This portion is in principle determined by the value of the 360° of the circumference of the wheel, divided by the number of vanes, because the vanes preferably adjoin edge to edge and do not overlap one another at the edges. However, this value can be modified knowingly by the designer. The values of the small and large diameters of the third washer define the pitch angle of the vanes in the fluid and are provided by default and can be corrected on demand by the designer. The diameters of the portions of circles (FIG. 4, R3) that construct the pressure side and the suction side of the blades are provided by default and corrected on demand by the designer of the wheel.

Preferably, at their largest diameter, the propeller vanes arriving at the third washer have pressure side and suction side blades that are secured to such washer by passing through same. The vanes of the propellers distribute at least one fluid into at least one peripheral chamber into which they open. At least one peripheral circular chamber is formed by the circular spaces contained between the circular portions of circle drawn by the designer (FIG. 3, C).

Straight lines which serve as references as the support length for the five parameters are drawn starting from points placed on the edge of the large and small diameter of the third washer (FIG. 6, L1, L2). They are continued towards the centre of the wheel with an angular value (FIG. 6) angle α from 0° to 90° with regard to the face of the third washer) provided by default like the other values of the five parameters which can also be corrected on demand.
At the centre of these lines are placed perpendicular lines (FIG. 6, P1, P2) on which the designer places the centres of the portions of circles which join the two ends of the lines. A circular groove is formed on an enlarged edge of the small diameter of the third washer, the values and position (FIG. 6, Y) of which are chosen by the designer. Profiled and oriented spacers are positioned between the portions of circle (FIG. 8, Ent) in order to make the fluid flow in the same direction as the wheel requires it to do so in order to rotate (FIG. 4, Rot), and radial spacers are placed between the second portion of circle and the small semicircle.

In a preferred embodiment of the invention, the turbine-propeller-jet hybrid wheel is a THR hybrid wheel that conveys ambient fluids. These wheels use, in addition to the turbine jet of the wheel, which acts with the ambient fluid, a highly energising fluid that is injected via the central shaft of the wheel, which is hollow. This fluid enters the hollow shaft behind the wheel. Then it is led to the inlet of the propeller vanes which are hollow and which are split into two separate parts (FIG. 3, Ps1, Ps2) with a radial vertical partition, or by a circular partition, which are continued along the entire length inside the vane. The diameter of the second washer of the wheel decreases towards the centre of the wheel and goes so far as to become connected with the outside of the tube of the hollow shaft which is cut at this place and which provides the fluid with high energy potential. A disc is placed towards the front of the wheel, a little before the second washer (FIG. 3, d). It starts from the axis of the wheel and creates therebetween a space which is closed by a cylindrical ring (FIG. 3, b) which continues the circular partition or caps the aforementioned radial vertical partitions which share the hollow propeller vanes. Radial spacers are placed in the aforementioned space therebetween.

In a preferred embodiment of the invention, the design method for fabricating a hybrid turbine-propeller-jet (THRE) wheel which uses an additional energising fluid that passes through the hollow vanes. It is characterised in that chambers are formed by the circular spaces contained between the three portions of circle (FIG. 3, C) which can be corrected on demand. A first large portion of circle is constructed with the image of the five parameters, the end of the straight line of which becomes a centre that is positioned on the large diameter of the third washer (FIG. 3, C). An angle α of a chosen value, from 0° to 90°, is drawn between the aforementioned reference straight line and the straight line of the given blade length with all the values of the five parameters which are provided by default and which can be corrected on demand by the designer.

A second portion of circle is constructed in the same way with the end of the straight line which becomes a centre that is positioned on the small diameter of the third washer (FIG. 6, C). An angle α of a chosen value, from 0° to 90°, is drawn between the aforementioned reference straight line and the straight line of the given blade length with all the values of the five parameters which are provided by default and which can be corrected on demand by the designer.
Another portion of circle is constructed in the same way with the end of the straight line, which becomes a centre that is positioned where the aforementioned partition reaches the third washer (FIG. 7).
An angle α of a chosen value, from 0° to 90°, is drawn between the aforementioned reference straight line and the straight line of the given blade length with all the values of the five parameters which are provided by default and which can be corrected on demand by the designer.
Profiled and oriented spacers are positioned between the portions of circle in order to make the fluid flow in the same direction as the wheel requires it to do so in order to rotate (FIG. 8). Radial spacers are placed between the second and the third portion of circle.

Preferably, for this arrangement of a THRE hybrid wheel which uses an additional energetic fluid, starting from the hollow of the shaft, the energising fluid is injected into tubes which follow the path described by passing through the hollow vanes of the propeller and end in the circular chambers located between the second and the third portion of circle adapted by the designer to receive the fluids.

Preferably, according to this design method for the fabrication of hybrid turbine-propeller-jet (THRE) wheels, electrical conductors are passed through the ducts usually reserved for the flow of fluids with high energy potential, said conductors ending at the peripheral chambers and being positioned to deliver the energy necessary to initiate an electric arc and/or to illuminate a light-emitting diode.

In a preferred embodiment of the invention, the whole hybrid turbine-propeller-jet wheel including the washers (FIG. 4, R1 R2 R3) is built using the five-parameter principle in its entirety and makes it possible to obtain, by means of infinitely small circle values, the cutting edges required for the penetration of the vanes and blades into the products. By using circles of any diameter (FIG. 1; 1, 2, 3) and straight lines (4, 5) it is possible to give the vanes and blades the desired material thickness. The camber can also be reversed and can be positive or negative.

The novel principle consists of taking the fluid at the centre to the inlet of a wheel and passing it through the hollow vanes of the propellers, benefiting from the centrifugal force and which end in a peripheral circular chamber provided with a circular opening which ejects the fluid towards the underside of the wheel, creating a reaction force by pressing on the boundary layers of fluid located nearby. The sum of the three principles allows for a considerable increase in axial thrust, since said thrust can be increased enormously by an energising fluid injected via the shaft into the jet engine, such as compressed air or even hydrogen, as in rockets.

A preferred feature of this method includes the fact that the neutral fibres are clad with material, using the principle of patent publication WO 2008/012425 (“CARPYZ” five-parameter principle) which constructs the area of a vane using only five parameters or mathematical values given to portions of geometric figures which have a reference centre, and are placed preferably in agreement with, or near, the values provided by the neutral fibres generated according to the present method. In particular, the neutral fibres are clad with material, using the five-parameter principle provided by the publication WO 2008/012425, and using as a basis the numerical values provided by the neutral fibres in order to place the material on either side of the fibre or at least partially covering it.

The design method according to the present invention simultaneously uses the principles of the turbine, the propeller and the jet in the same wheel. These principles combined make it possible to obtain much greater axial thrusts than the propeller alone. For the mathematical parametrisation which makes all the elements dependent on one another, very powerful computer tools are used: Pro Engineer Créo, Dassault Systèmes Catia, etc.

### BRIEF DESCRIPTION OF THE FIGURES

The figures are provided for information and are schematic and simplified to best illustrate the texts of the description and the claims.

FIG. 1 shows the so-called five-parameter principle;

FIG. 2 shows feeding blades between two washers constructed with recesses or bulges and are optionally twisted in a positive or negative manner on demand using the five parameters;

FIG. 3 shows in section the supply of energising fluid injected via the hollow shaft and its passage to the underside of the wheel.

FIG. 4 shows a THRE wheel viewed from the front, the blades being characterised in four sectors on the surface of a circle;

FIG. 5 shows an example of a THR wheel produced with the three areas;

FIG. 6 shows the construction of the chamber of the THR wheel made with curves generated infinitely by scaling the five “CARPYZ” parameters;

FIG. 7 shows the construction of chambers of the THRE wheel made with curves generated infinitely by scaling the five “CARPYZ” parameters; and

FIG. 8 shows in section the orientation given to the fluid at the outlet of the vanes, by spacers defined by the five parameters.

### DETAILED DESCRIPTION OF THE INVENTION

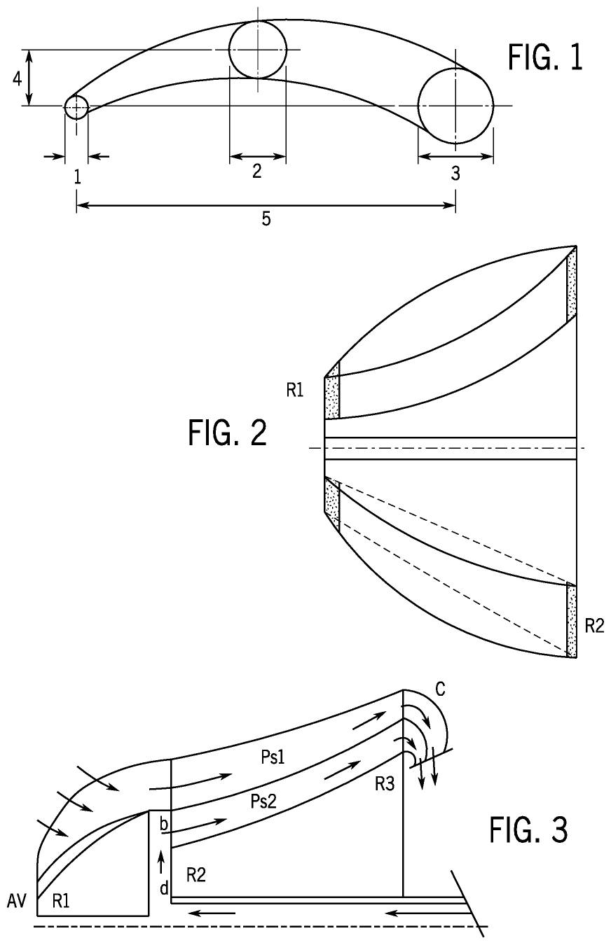

FIG. 1 shows the so-called five-parameter principle.

### Designing the “Turbine-Propeller-Jet” THR Wheel

THR wheels simultaneously use three fundamental principles of nature:

that of the propeller whose pressure is supplied by kinetic energy and which is directly proportional to the speed of rotation of the wheel, =PROPELLER (blocked by Betz's law)

that of the turbines which use centrifugal force which provide a pressure proportional to the square of the speed of rotation of the wheel, =TURBINE

that of a jet of fluid, which presses on the ground and on the fluid boundary layers located nearby and which surround it, such as rockets or aeroplanes =JET.

The methods for constructing and fabricating THR wheels are shown on so-called “neutral fibre” lines represented without the material, which will then clad them on demand in various materials.
To create, construct and fabricate THR wheels, they are first designed and displayed on the screen, starting with a basic image of the wheel designed by “CARPYZ” that is infinitely scalable by modifying the geometric and mathematical and numerical values of the constituent elements, provided by default.

For the sake of simplicity in the figures provided, the construction elements of the five parameters, which are provided by the designer of the wheel during its construction, are not shown.

Each element of the THR wheels can be scaled using the specific software package created by “CARPYZ”, supported by a powerful computer tool, which through mathematical parametrisation combine and make all the constituent elements dependent on one another. To design and fabricate its wheels, “CARPYZ” uses its “so-called five-parameter principle”, which makes it possible to create, in an infinite manner, vanes of all lengths and hollow and convex curves on demand, by manipulating only five numerical values (publication WO2008/012425), which are:

a value for a geometric figure which has a centre, at the left edge of the vane, a value for a geometric figure which has a centre, at the right edge of the vane, a value for the diameter of a circle placed at the centre of the vane for its body, a value for the camber determined by the position of the three aforementioned circles relative to one another, and a value for the length of the vane provided between the two centres of the two edges.

It should be noted that the numerical values authorised by the computers make it possible to achieve very thin edges that can even be sharp, something that is difficult to achieve using Bezier curves and NURBS.
The present invention shows how THR wheels are constructed using known geometric and mathematical principles and laws, but which are associated and used simultaneously or independently in complementary ways. Each principle, while already known elsewhere, cannot be regarded as sufficient opposition having been taken out of the overall context which is claimed, since the elements of the one-piece wheel are, by definition, all dependent on one another.

FIG. 2 shows, by way of example, feeding blades between the two washers R1 and R2 which are constructed with recesses or bulges and are optionally twisted in a positive or negative manner on demand with the five parameters.

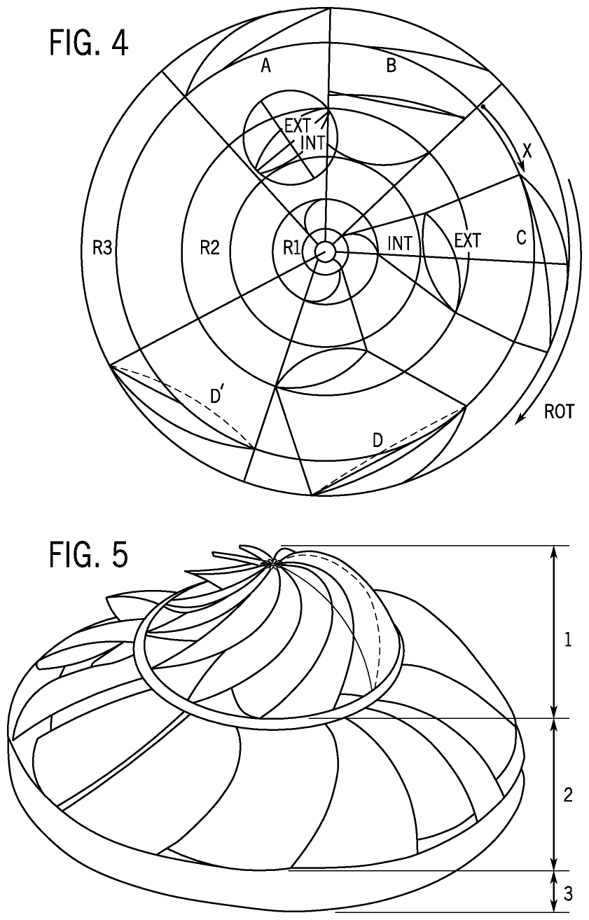

FIG. 3 shows the supply of energising fluid injected via the hollow shaft, which passes between the second washer and a disc, the large diameter space of which is blocked by a cylindrical ring which continues the circular partition which passes all the way through the hollow vane of the propeller. The vane passes through the third washer. As can be seen in FIG. 3, the fluids are then directed by the chambers towards the underside of the wheel.

### Turbine-Propeller-Jet Wheel, THRA

The wheels are symmetrical and rotate on demand to the right or to the left.
The wheels are produced over three main areas separated by three washers:

the first area allows the fluid to be taken from the intake blades into the ambient environment. Each blade starts from a first small washer placed at the front at the centre of the wheel, on which the small profile of the intake blade is configured. A second washer offset towards the rear of the wheel on which the large profile of the intake blade is configured. The intake blades are generated by the computer between these two first washers and direct the fluid towards the inlet of the hollow vanes of the propeller which is placed on the second washer. It should also be noted that the profile of the large intake blade is the same as the profile of the blade of the suction side of the vane at the inlet of the propeller.

the second area allows the blades of the propellers to absorb at their inlet the fluid supplied by the intake blade of the first area and to cause it to migrate into the interior of their vanes from the front to the back of the wheel by crossing the propeller vanes which are hollow until a third washer.

the third area has at least one circular chamber placed after the third washer, which receives the fluid at the outlet of the hollow vanes of the propeller and directs it towards the rear of the propeller, which, by means of a calibrated and oriented circular opening, allows it to generate a force by reaction.

As indicated in the publication WO 2016/110364 A1, the section of the inlet of the duct of the hollow vanes of the propeller of a wheel is drawn with the help of geometric figures that use portions of circle constructed on the two points of the ends of a fleeting chord. One of the ends of this chord is positioned on the circle described by the leading edge of the vanes of the wheel as they rotate, and the chord is angularly positioned, preferably at 45° with respect to a spoke of the wheel.
Starting from a centre placed in the middle of this fleeting chord, a circle is drawn which passes through the two ends of the chord. A perpendicular line which crosses the chord is drawn on this centre point. The centre points which are located at the intersection of the circle and the perpendicular line make it possible to draw the sought portions of circle of which the ends merge with those of the fleeting chord.
The two portions of circle obtained are at the inlet to the vane: the blade of the convex suction side of the vane blade and the blade of the concave pressure side of the blade, and the chord disappears.

### First Wheel Area

The “CARPYZ” turbine-propeller-jet wheel is made up, viewed in section along the length, of a first area provided with blades intended for taking the ambient fluid and for supplying the inlet of the hollow vanes of the propeller with which they are aligned.
The powered, energetic hybrid turbine-propeller, turbine-propeller-jet wheels use blades for the first area of the wheel which are generated using the mathematical five-parameter principle (WO 2008/012425) which allows curves to be created using only five numerical values and which are applied first on the inside face of a small washer that is flat, inclined or curved. This first washer is located near the centre at the front of the wheel. The rear face of this small washer is first used to draw the blade profile moving downstream. The leading edge of the blade is placed on the large diameter of the circle of the small washer, and the trailing edge is placed on the small diameter of the small washer. The second washer receives a profile similar to that of the blade sent by the first washer of the wheel, which is thus aligned with the blade of the suction side of the vane. The twisting of the blade is obtained on demand by a desired angular offset between the first two washers.

### Second Wheel Area

The “turbine-propeller-jet” wheel is made up, as viewed in longitudinal cross-section, of a second area which is occupied by the vanes of the propeller which are intended for transferring the ambient fluid that surrounds the front wheel from the front to the rear. The profiles given to the vanes are straight, curved or hollow on demand, and are straight or twisted in + or − by angular offset of the washers therebetween.

### Third Wheel Area

The “turbine-propeller-jet” wheel is made up, as viewed in longitudinal cross-section, of a third area placed at the rear of the wheel, which consists of at least one circular chamber placed behind a third washer. It receives the fluid supplied by the hollow of the propeller blades at their large diameter. This chamber is provided on the bottom with a calibrated slot directed towards the rear of the wheel, all around at the periphery thereof.

FIG. 4 shows, by way of example, a THRE wheel viewed from the front with the blades characterised in each sector

FIG. 4 sector A shows on the surface of a portion of circle of the wheel viewed from the front with the indicated direction of rotation to the right, and on sector A at the centre on the small washer R1 the profile of a small vane moving downstream (crossed out) which has its leading edge in line, with no angular offset with the leading edge of the suction side of the blade inlet (crossed out), shown on the second washer R2.
There is also no angular offset with the leading edge of the suction side where it reaches the chamber as shown on the third washer R3 (crossed out). The pressure side is concave on R2 and convex on R3.
FIG. 4 also shows the portions of the crown of the circular chamber of the third area which cap the periphery of the wheel. They are delimited by the leading and trailing edges of each vane where it reaches the chamber. On Sector A the washer R2 shows the geometric outline used for injecting the fluid at the inlet of the propeller vane.
FIG. 4 sector B shows on the surface of a circle the wheel viewed from the front, the switch from concave to convex of the pressure side which takes place at the middle of the blade by two half blades, one starting from R2 and the another leading to R3, and which meet at the centre and overlap very slightly.
FIG. 4 sector C shows the wheel viewed from the front, one vane twisted forwards moving downstream.
FIG. 4 sector D shows the wheel viewed from the front, one vane twisted towards the rear while retreating, and the concave dotted, convex or flat pressure side.

FIG. 5 shows an example of a wheel produced with the three areas.

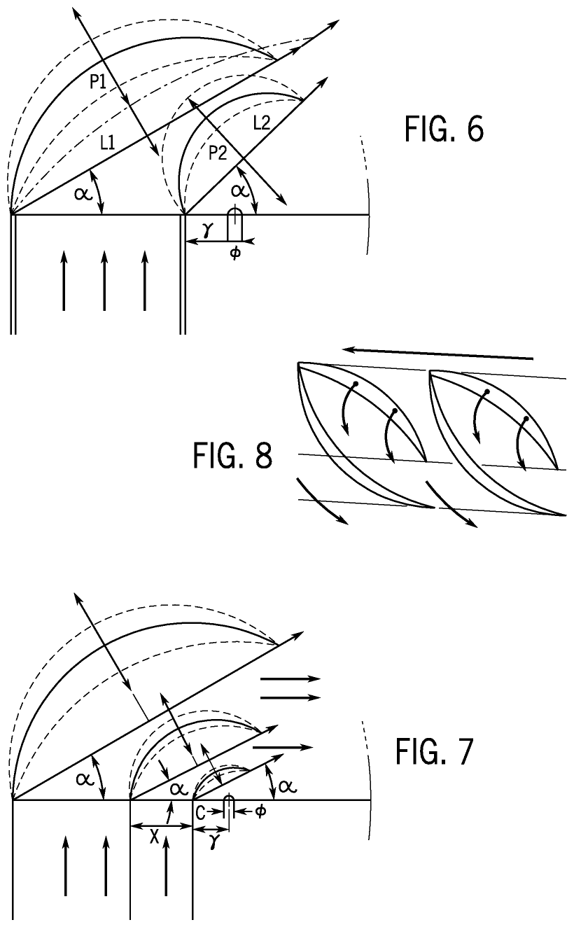

FIG. 6 shows the construction of the THR wheel chamber made with curves generated infinitely by scaling the five “CARPYZ” parameters according to the angle of support of the length, and the other parameters of length, diameter, etc.

FIG. 7 shows the construction of the THRE wheel chambers made with curves generated infinitely by scaling the five “CARPYZ” parameters: angle of support of the length, length, diameter, etc.

FIG. 8 shows in section the orientation given to the fluid at the outlet of the vanes, by spacers defined by the five parameters.

According to the method for designing, constructing and fabricating a turbine-propeller-jet (THR) wheel according to the invention, the skeleton of the one-piece wheel is constructed using a CARPYZ software package that provides a basic image where all the essential constituent elements are cited with numerical and arithmetic values that are provided by default by using the “CARPYZ” five-parameter principle.

This image is created by the “CARPYZ” software package with values provided intuitively according to the wheels already produced but which can be scaled infinitely according to the expected use of the designed wheel (for example: diameters, number of vanes, shape of the vanes, profile of the chambers, etc.) by continuously using the “CARPYZ” five-parameter principle (publication WO2008/012425). This image shows a first area (1) intended for feeding the inlet of the hollow vanes of the propeller by blades, the profile of which is designed on the rear face of a first small washer, the diameters of which are provided by default, positioned on the axis in front of the wheel (4 R1).

If the wheel viewed from the front rotates to the right in a clockwise direction, the right edge of the blade is placed on the large diameter of the washer, and the left edge of the length of the blade is placed on the small diameter of the washer and is angularly offset towards the rear. The values, edges, body, angular offset between edges, length and camber are values provided by default for the blade, and are corrected on demand by the designer of the wheel.

Another blade profile similar to the previous one is also drawn with the five parameters on the front face of a second larger washer (4 R2 A). The blade is generated by the computer between the two profiles with the five parameters. A value is provided for the distance that separates the two washers and the angular offset between the two washers which allows the blades to twist positively or negatively are provided by default and are corrected by the designer. The blades are then said to be neutral, or moving downstream or being withdrawn. The large profile of the intake blade is connected to and merges with that of the suction side of the inlet of the propeller vane which is also subjected to the five parameters.

The wheel is rotated by a shaft secured to the centre of the second washer, and rotates in the chosen direction of rotation. This first resolution shows how the front of the wheel is constructed, which is inseparable from the one-piece wheel.

The design method for fabricating the turbine-propeller-jet (THR) wheel according to the present invention simultaneously uses the principles of the turbine, the propeller and the jet in the same wheel. These principles combined make it possible to obtain much greater axial thrusts than the propeller alone. For the mathematical parametrisation which makes all the elements dependent on one another, very powerful computer tools, such as Pro Engineer Créo, Dassault Systèmes Catia, etc., can be used.

In a preferred embodiment, on the rear face of the second washer is positioned the inlet of the hollow vanes of the propeller which constitute the second area (2) of the wheel. The intake blades of the first area are merged with the blades of the suction side of the vanes which are also subjected to the five parameters. The fluid inlet is located on the small diameter of the propeller vanes (publication WO/2016/110364). The fluid outlet is located on the large diameter of the vanes. The vanes are made up of two blades and the fluid which they convey flows at their large diameter into at least one circular chamber which is the third area (3). A value is provided for the distance that separates the second and third washers and the angular offset between the two washers which allows the blades to twist positively or negatively are provided by default and are corrected by the designer. The blades are then said to be neutral, or moving downstream or being withdrawn. The suction side blade of the vane is convex at the inlet of the vane and at the outlet of the vane (FIG. 4, A,R1,2,3). The pressure side blade of the vane is concave at the inlet of the vane and convex, flat or convex at the outlet of the vane (FIG. 4, R3,D,D′).

Preferably, the switch from concave to convex of the pressure side blade of the propeller vane takes place towards the middle of the length thereof It is split into two half-vanes which use the five parameters, the first concave part of the second washer and the other convex part arrive on the third washer, and they meet towards the centre with a slight overlap.

In a preferred embodiment, the vanes of the propeller arrive on the front face of the third washer through which they pass. The right edge of the vane is placed on the large diameter of the washer. The left edge of the vane is placed on the small diameter of the washer. The length of the vanes is provided by the angular portion of the washers in which they fit. This portion is in principle determined by the value of the 360° of the circumference of the wheel, divided by the number of vanes, because preferably the vanes adjoin edge to edge and do not overlap one another at the edges. However, this value can be modified knowingly by the designer. The values of the small and large diameters of the third washer define the pitch angle of the vanes in the fluid and are provided by default and can be corrected on demand by the designer. The diameters of the portions of circles that construct the pressure side and the suction side of the blades are provided by default and corrected on demand by the designer of the wheel.

Preferably, at their largest diameter, the propeller vanes arriving at the third washer have pressure side and suction side blades that are secured to such washer by passing through same. The vanes distribute at least one fluid into at least one peripheral chamber into which they open. At least one chamber is formed by the circular spaces contained between the circular portions of circle drawn by the designer.

A straight line which serves as a reference is drawn between the large and the small diameter of the edge of the third washer and is continued towards the centre of the wheel with a value that is provided by default and can be corrected on demand.
A first large portion of circle is constructed with the image of the five parameters, the left edge of the length of the blade of which becomes a centre, which is positioned on the large diameter of the third washer. An angle of a chosen value, from 0° to 90°, is drawn between the aforementioned reference straight line and the straight line of the given vane length with all the values of the five parameters which are provided by default and which can be corrected on demand by the designer. A second portion of circle is constructed with the image of the five parameters, the left edge of the length of the blade of which becomes a centre, which is positioned on the small diameter of the third washer. An angle of a chosen value, from 0° to 90°, is drawn between the aforementioned reference straight line and the straight line of the given vane length with all the values of the five parameters which are provided by default and which can be corrected on demand by the designer. A small semicircle is drawn on the reference line, the centre of which is positioned at a distance from the previously mentioned centre, and is provided by default, with its diameter. Profiled and oriented spacers are positioned between the portions of circle in order to make the fluid flow in the same direction as the wheel requires it to do so in order to rotate. Between the second portion of circle and the small semicircle are placed radial spacers.

In a preferred embodiment, the “turbine-propeller-jet” wheel is a wheel “fed” by an additional highly energising fluid injected from outside the “THRE” wheel. This hybrid wheel can simultaneously use the propeller and the turbine which acts, on the one hand, with the ambient fluid, and on the other uses an additional fluid with high energy potential which is injected behind or in front of the wheel by the centre of a hollow shaft which also ensures the rotation of the wheel.

These THRE hybrid wheels convey ambient fluids and use in addition to the turbine-jet of the wheel which acts with the ambient fluid, a highly energising fluid that is injected via the central shaft of the wheel, which is hollow. This fluid enters the hollow shaft behind the wheel. Then it is led to the inlet of the propeller vanes which are hollow and which are split into two separate parts, or by a radial vertical partition, or by a circular partition, which are continued along the entire length inside the vane. The diameter of the second washer of the wheel decreases towards the centre of the wheel and goes so far as to become connected with the outside of the tube of the hollow shaft which is cut at this place and which provides the fluid with high energy potential. A disc is placed towards the front of the wheel, a little before the second washer (FIG. 3). It starts from the axis of the wheel and creates therebetween a space which is closed by a cylindrical ring which continues the circular partition or caps the aforementioned radial vertical partitions and which share the hollow propeller blades. Radial spacers are placed in the aforementioned space therebetween.

In a preferred embodiment, the design method for the fabricating a hybrid turbine-propeller-jet (THRE) wheel which uses an additional energising fluid is characterised in that, when they reach their largest diameter, the hollow vanes join their suction side and their pressure side by passing through the third washer. They distribute their fluids in peripheral chambers which follow the pressure side and suction side blades and the partitions contained in the hollow vanes. These chambers are formed by the circular spaces contained between the three portions of circle.

A straight line which serves as a reference is drawn between the large and the small diameter of the edge of the third washer and is continued towards the centre of the wheel with a value that is provided by default and can be corrected on demand.
A first large portion of circle is constructed with the image of the five parameters, the left edge of the length of the blade of which becomes a centre, which is positioned on the large diameter of the third washer. An angle of a chosen value, from 0° to 90°, is drawn between the aforementioned reference straight line and the straight line of the given vane length with all the values of the five parameters which are provided by default and which can be corrected on demand by the designer.
A second portion of circle is constructed with the image of the five parameters, the left edge of the length of the blade of which becomes a centre, which is positioned on the small diameter of the third washer. An angle of a chosen value, from 0° to 90°, is drawn between the aforementioned reference straight line and the straight line of the given vane length with all the values of the five parameters which are provided by default and which can be corrected on demand by the designer.
Another portion of circle is constructed with the image of the five parameters, the left edge of the length of the blade of which becomes a centre, which is positioned where the partitions reach the third washer. An angle of a chosen value, from 0° to 90°, is drawn between the aforementioned reference straight line and the straight line of the given vane length with all the values of the five parameters which are provided by default and which can be corrected on demand by the designer. Profiled and oriented spacers are positioned between the portions of circle in order to make the fluid flow in the same direction as the wheel requires it to do so in order to rotate (FIG. 4). Radial spacers are placed between the second and the third portion of circle.

Preferably, for this arrangement of a THRE hybrid wheel which uses an additional energising fluid, starting from the hollow of the shaft, the energising fluid is injected into tubes which follow the path described by passing through the hollow vanes of the propeller and end in the circular chambers located between the second and the third portion of circle adapted by the designer to receive same.

Preferably, according to this design method for the fabrication of hybrid turbine-propeller-jet (THRE) wheels, electrical conductors are passed through the ducts usually reserved for the flow of fluids with high energy potential, said conductors ending at the peripheral chambers and being positioned to deliver the energy necessary to initiate an arc and/or to illuminate a light-emitting diode, for example.

The novel principle consists of taking the fluid at the centre to the inlet of a wheel and passing it through the hollow vanes of the propellers, benefiting from the centrifugal force and which end in a peripheral circular chamber provided with a circular opening which ejects the fluid towards the underside of the wheel, creating a reaction force by pressing on the boundary layers of fluid located nearby. The sum of the three principles allows for a considerable increase in axial thrust, since said thrust can be increased enormously by an energising fluid injected via the shaft into the jet engine, such as compressed air or even hydrogen, as in rockets.

A preferred feature of this method includes the fact that the neutral fibres are clad with material, using the principle of patent publication WO 2008/012425 (“CARPYZ” five-parameter principle) which constructs the area of a vane using only five parameters or mathematical values given to portions of geometric figures which have a reference centre, and are placed preferably in agreement with, or near, the values provided by the neutral fibres generated according to the present method. In particular, the neutral fibres are clad with material, using the five-parameter principle provided by the publication WO 2008/012425, and using as a basis the numerical values provided by the neutral fibres in order to place the material on either side of the fibre or at least partially covering it.

The design method according to the present invention simultaneously uses the principles of the turbine, the propeller and the jet in the same wheel. These principles combined make it possible to obtain much greater axial thrusts than the propeller alone. For the mathematical parametrisation which makes all the elements dependent on one another, very powerful computer tools are used: Pro Engineer Créo, Dassault Systèmes Catia, etc.

The present invention is not in any way limited to the embodiment described by way of example and shown in the drawings. Numerous modifications of the details, shapes and dimensions could be made without departing from the scope of the invention. The present invention has been described with reference to specific embodiments which are purely illustrative and should not be considered limiting. The reference numbers in the claims do not limit the scope thereof.

1. A method for designing, constructing and fabricating a turbine-propeller-jet (THR) wheel for all fluids, wherein:
the skeleton of the wheel is constructed between three washers (FIG. 3, R1-R2-R3), the three washers (FIG. 3, R1-R2-R3) being concentric with the axis of rotation and axially spaced apart from one another in the general axial direction of flow, the wheel comprises three areas, including the upstream side (FIG. 3, AV) of the wheel viewed in a meridional plane containing the axis of rotation made up of a first area (1) of the fluid inlet, of which the propeller (FIG. 5, 2) constitutes a second area (2), and of which a chamber (FIG. 5, 3) under the wheel constitutes a third area (3), said chamber acting, through peripheral circular slots, as a jet engine,
the first area (1) extending axially from the first washer (R1) to the second washer (R2), the second area (2) extending axially from the second washer (R2) to the third washer (R3), and the third area (3) extending axially away from the third washer (R3) in the downstream direction,
in the first area (1) blades extend axially between the first washer (R1) and the second washer (R2), in the second area (2) hollow vanes of the propeller extend axially between the second washer (R2) and the third washer (R3), the interior of each of these hollow vanes having an inlet located in the plane of the second washer (R2),
a certain geometry of the skeleton is defined by continuously using the “CARPYZ” principle known as the five-parameter principle (FIG. 1) for the configuration of the elements that constitute hollow helical wheels or their cages, which is based on the use of geometric figures, the centres of which serve as a reference for constructing same and defining their areas, the values of angles, centre offsets and pitches making it possible to control said constituent elements and to combine curves together as desired by superimposing the centres thereof,
the first area (FIG. 5, 1) favours the penetration of the fluid into the inlet of the hollow vanes of the propeller (FIG. 4, A R2),
the profile of such blades of the first area (FIG. 5, 1) being designed on the downstream face of a first washer placed upstream of the wheel (FIG. 3, R1), the diameters of which are provided by default, positioned on the axis upstream of the wheel (FIG. 4, R1 and FIG. 2, R1),
another blade profile similar to the previous one is projected with the five parameters (FIG. 4, R2) on the upstream face of the second washer (FIG. 4, R2 A),
each blade is generated between the profiles of the two washers with the five parameters, values being provided, for the distance that separates the two washers and for the angular offset between the two washers which makes it possible to twist the blades, positively or negatively, are provided by default and are corrected by the designer, the blades are then said to be neutral, or moving downstream or being withdrawn,
the suction side (FIG. 4, R2 Ext) of the inlet of the propeller vane is also subjected to the five parameters,
the wheel is rotated by a shaft secured to the centre downstream of the wheel in the meridional plane containing the axis of rotation, and rotates in the chosen direction of rotation which is reversible (FIG. 4, Rot), from which the upstream side of the wheel is constructed, which is inseparable from the downstream side of the wheel (FIG. 5,1-2-3), characterised in that:
(i)—the skeleton of the one-piece wheel is constructed between three washers (FIG. 3, R1-R2-R3) using a specific software package that provides a basic image of the skeleton (FIG. 5) where all the constituent elements of the wheel are cited with numerical and arithmetic values that are provided by default in a non-exhaustive manner, this image of the skeleton being created arbitrarily by the software package,
with the image of the skeleton shown on the screen values determined intuitively are provided, according to the wheels already produced but which can be scaled infinitely according to the expected use of the designed wheel (for example: diameters, number of vanes, shape of the vanes, profile of the chambers, etc.), by continuously using the “CARPYZ” principle, known as the five-parameter principle (FIG. 1) to configure the skeleton of the wheel,
this basic image of the skeleton shows the blades of the first area (FIG. 5, 1), and the geometry of the blade is generated by the computer between the profiles of the two washers with the five parameters,
(ii)—if the wheel is viewed in a direction parallel to the axis of rotation and rotates clockwise (FIG. 4, Rot), the upstream edge of the blade is placed on the large diameter of the washer and the downstream edge of the blade is placed on the small diameter of the washer and is angularly offset,
the values of the angular offset between the upstream and downstream edges of the blade and the camber thereof are values provided by default with the five parameters and are corrected on demand by the designer of the wheel,
(iii) the large profile of the intake blade on the second washer (FIG. 4, R2) is connected to and preferably merges with that of the suction side (FIG. 4, R2 Ext) of the inlet of the propeller vane,
(iv)—the skeleton of the wheel is in one piece,
the upstream side of the wheel is inseparable from the downstream side of the wheel, which is preferably in one piece (FIG. 5, 1-2-3),
the second washer (FIG. 4, R2 A) defines the pressure side (FIG. 4, R2 Int) and the suction side (FIG. 4, R2 Ext) of the inlet of the vane,
(v) in that:
at their largest diameter, the propeller vanes arriving on the third washer have pressure side and suction side blades that are secured to such washer by passing through same, the vanes of the propellers distribute at least one fluid into at least one peripheral chamber into which they open, at least one peripheral circular chamber being formed by the circular spaces contained between the circular portions of circle defined by the designer (FIG. 3, C), and
(vi) in that, viewed in a meridional plane containing the axis of rotation:
straight lines which serve as references as the support length for the five parameters, are drawn starting from points placed on the edge of the large and small diameter of the third washer (FIG. 6, L1, L2), and they are continued towards the centre of the wheel at an angular value (FIG. 6, α) from 0° to 90° with regard to the face of the third washer which are provided by default like the other values of the five parameters which can also be corrected on demand,
at the centre of these lines are placed perpendicular lines (FIG. 6, P1, P2) on which the designer places the centres of the portions of circles which join the two ends of the lines, a circular groove is formed on an enlarged edge of the small diameter of the third washer, the values and position (FIG. 6, Y) of which are chosen by the designer, and
profiled and oriented spacers are positioned between the portions of circle (FIG. 8) in order to make the fluid flow in the same direction as the wheel requires it to do so in order to rotate (FIG. 4, Rot), and radial spacers are placed between the second portion of the circle and the small semicircle.

2. The method for designing, constructing and fabricating a turbine-propeller-jet (THR) wheel according to claim 1, wherein:
on the downstream face of the second washer is positioned the inlet of the hollow vanes of the propeller which constitute the second area (2) of the wheel, the blades of the first area are brought into line with the blades of the suction side (FIG. 4, R2 Ext) of the vanes (FIG. 4, A) which are also adapted to the five parameters.
the fluid inlet is located on the small diameter of the vanes and the fluid outlet is located on the large diameter of the vanes,
the vanes consist of two blades and open at their large diameter into a circular chamber located at the rear, which is the third area (FIG. 5, 3).
the suction side blade (FIG. 4, R2 Ext) of the vane, viewed axially on an orthoaxial section plane, is convex at the inlet of the vane and at the outlet of the vane (FIG. 4, R3 A), and
the pressure side blade (FIG. 4, R2 Int) of the vane, viewed axially on an orthoaxial section plane, is concave at the inlet of the vane and convex at the outlet of the vane (FIG. 4, R3 Int).

3. The method for designing, constructing and fabricating a turbine-propeller-jet (THR) wheel according to claim 1, wherein:
the vanes of the propeller open onto the upstream face of the third washer (FIG. 3, R3) through which they pass,
the right edge of the vane (FIG. 4, R3 A, B, C, D), viewed axially on an orthoaxial section plane, is placed on the large diameter of the washer and the left edge of the vane (FIG. 4, R3 A, C, D), viewed axially on an orthoaxial section plane, is placed on the small diameter of the washer,
the length of the vanes is given by the angular portion of the washers in which they fit, this portion is in principle determined by the value of the 360° of the circumference of the wheel, divided by the number of vanes, because preferably the vanes adjoin edge to edge and do not overlap one another at the edges; however, this value can be modified knowingly by the designer.

4. The method for designing, constructing and fabricating a turbine-propeller-jet (THR) wheel which conveys ambient fluids, the wheel being a THRE hybrid wheel, which uses an additional highly energising fluid, according to claim 1, wherein:
the THRE hybrid wheel uses, in addition to the turbine jet of the wheel, which acts with the ambient fluid, a highly energising fluid that is injected via the central shaft of the wheel, which is hollow,
this fluid enters the hollow shaft downstream of the propeller and then it is led to the inlet of the propeller vanes which are hollow and which are split into two separate parts (FIG. 3, Ps1, Ps2) with a radial vertical partition, or by a circular partition, which are continued along the entire length inside the vane,
the diameter of the second washer of the wheel decreases towards the centre of the wheel and goes so far as to become connected with the outside of the tube of the hollow shaft which is cut at this place and which provides the fluid with high energy potential,
a disc is placed towards the upstream side of the wheel, a little upstream of the second washer (FIG. 3, d), this disc starts from the axis of the wheel and creates therebetween a space which is closed by a cylindrical ring (FIG. 3, b) which continues the circular partition or caps said radial vertical partitions which share the hollow propeller vanes, radial spacers are placed in the space therebetween.

5. The method for designing, constructing and fabricating a hybrid turbine-propeller-jet (THRE) wheel which uses an additional energising fluid that passes through the hollow vanes, according to claim 4, wherein:
a first large portion of circle is constructed with the image of the five parameters, the end of the straight line of which becomes a centre that is positioned on the large diameter of the third washer (FIG. 3, C),
an angle (α) of a chosen value, from 0° to 90°, is drawn between the aforementioned reference straight line and the straight line of the given blade length with all the values of the five parameters which are provided by default and which can be corrected on demand by the designer.
a second portion of circle is constructed with the image of the five parameters in the same way with the end of the straight line which becomes a centre that is positioned on the small diameter of the third washer (FIG. 6, C),
an angle (α) of a chosen value, from 0° to 90°, is drawn between the aforementioned reference straight line and the straight line of the given blade length with all the values of the five parameters which are provided by default and which can be corrected on demand by the designer,
another portion of circle is constructed with the image of the five parameters in the same way with the end of the straight line, which becomes a centre that is positioned where the aforementioned partition reaches the third washer (FIG. 7).
an angle (α) of a chosen value, from 0° to 90°, is drawn between the aforementioned reference straight line and the straight line of the given blade length with all the values of the five parameters which are provided by default and which can be corrected on demand by the designer,
profiled and oriented spacers are positioned between the portions of circle in order to make the fluid flow in the same direction as the wheel requires it to do so in order to rotate (FIG. 8), and radial spacers are placed between the second and the third portion of circle.

6. The method for designing, constructing and fabricating a hybrid turbine-propeller-jet (THRE) wheel which uses an additional energising fluid, according to claim 4 wherein:
starting from the hollow of the shaft, the energising fluid is injected into tubes which follow the path described which pass through the hollow vanes of the propeller and end in the circular chambers located between the second and the third portion of circle adapted by the designer to receive the fluids.

7. The method for designing, constructing and fabricating a hybrid turbine-propeller-jet (THRE) wheel which uses an additional energising fluid, according to claim 4, wherein:
electrical conductors are passed through the ducts usually reserved for the flow of fluids with high energy potential, said conductors ending at the peripheral chambers and being positioned to deliver the energy necessary to initiate an electric arc and/or to illuminate a light-emitting diode.

8. The method for designing, constructing and fabricating a turbine-propeller-jet (THR) wheel according to claim 1, wherein:
the whole wheel including the washers (FIG. 4, R1 R2 R3) is constructed using the five-parameter principle in its entirety and makes it possible to obtain, by means of infinitely small circle values, the sharp edges required for the penetration of the vanes and blades into the products, so that by using circles of any diameter (FIG. 1; 1, 2, 3) and straight lines (4, 5) it is possible to give the vanes and blades the desired material thickness. The camber can also be reversed and can be positive or negative.

9. The method for designing, constructing and fabricating a turbine-propeller-jet (THR) wheel according to claim 2, wherein:
the vanes of the propeller open onto the upstream face of the third washer (FIG. 3, R3) through which they pass,
the right edge of the vane (FIG. 4, R3 A, B, C, D), viewed axially on an orthoaxial section plane, is placed on the large diameter of the washer and the left edge of the vane (FIG. 4, R3 A, C, D), viewed axially on an orthoaxial section plane, is placed on the small diameter of the washer,
the length of the vanes is given by the angular portion of the washers in which they fit, this portion is in principle determined by the value of the 360° of the circumference of the wheel, divided by the number of vanes, because preferably the vanes adjoin edge to edge and do not overlap one another at the edges; however, this value can be modified knowingly by the designer.

10. The method for designing, constructing and fabricating a turbine-propeller-jet (THR) wheel which conveys ambient fluids, the wheel being a THRE hybrid wheel, which uses an additional highly energising fluid, according to claim 2, wherein:
the THRE hybrid wheel uses, in addition to the turbine jet of the wheel, which acts with the ambient fluid, a highly energising fluid that is injected via the central shaft of the wheel, which is hollow,
this fluid enters the hollow shaft downstream of the propeller and then it is led to the inlet of the propeller vanes which are hollow and which are split into two separate parts (FIG. 3, Ps1, Ps2) with a radial vertical partition, or by a circular partition, which are continued along the entire length inside the vane,
the diameter of the second washer of the wheel decreases towards the centre of the wheel and goes so far as to become connected with the outside of the tube of the hollow shaft which is cut at this place and which provides the fluid with high energy potential,
a disc is placed towards the upstream side of the wheel, a little upstream of the second washer (FIG. 3, d), this disc starts from the axis of the wheel and creates therebetween a space which is closed by a cylindrical ring (FIG. 3, b) which continues the circular partition or caps said radial vertical partitions which share the hollow propeller vanes, radial spacers are placed in the space therebetween.

11. The method for designing, constructing and fabricating a turbine-propeller-jet (THR) wheel which conveys ambient fluids, the wheel being a THRE hybrid wheel, which uses an additional highly energising fluid, according to claim 3, wherein:
the THRE hybrid wheel uses, in addition to the turbine jet of the wheel, which acts with the ambient fluid, a highly energising fluid that is injected via the central shaft of the wheel, which is hollow,
this fluid enters the hollow shaft downstream of the propeller and then it is led to the inlet of the propeller vanes which are hollow and which are split into two separate parts (FIG. 3, Ps1, Ps2) with a radial vertical partition, or by a circular partition, which are continued along the entire length inside the vane,
the diameter of the second washer of the wheel decreases towards the centre of the wheel and goes so far as to become connected with the outside of the tube of the hollow shaft which is cut at this place and which provides the fluid with high energy potential,
a disc is placed towards the upstream side of the wheel, a little upstream of the second washer (FIG. 3, d), this disc starts from the axis of the wheel and creates therebetween a space which is closed by a cylindrical ring (FIG. 3, b) which continues the circular partition or caps said radial vertical partitions which share the hollow propeller vanes, radial spacers are placed in the space therebetween.

12. The method for designing, constructing and fabricating a hybrid turbine-propeller-jet (THRE) wheel which uses an additional energising fluid, according to claim 8, wherein:
starting from the hollow of the shaft, the energising fluid is injected into tubes which follow the path described which pass through the hollow vanes of the propeller and end in the circular chambers located between the second and the third portion of circle adapted by the designer to receive the fluids.

13. The method for designing, constructing and fabricating a hybrid turbine-propeller-jet (THRE) wheel which uses an additional energising fluid, according to claim 8, wherein:
electrical conductors are passed through the ducts usually reserved for the flow of fluids with high energy potential, said conductors ending at the peripheral chambers and being positioned to deliver the energy necessary to initiate an electric arc and/or to illuminate a light-emitting diode.

14. The method for designing, constructing and fabricating a hybrid turbine-propeller-jet (THRE) wheel which uses an additional energising fluid, according to claim 9, wherein:
electrical conductors are passed through the ducts usually reserved for the flow of fluids with high energy potential, said conductors ending at the peripheral chambers and being positioned to deliver the energy necessary to initiate an electric arc and/or to illuminate a light-emitting diode.

15. The method for designing, constructing and fabricating a turbine-propeller-jet (THR) wheel according to claim 2, wherein:
the whole wheel including the washers (FIG. 4, R1 R2 R3) is constructed using the five-parameter principle in its entirety and makes it possible to obtain, by means of infinitely small circle values, the sharp edges required for the penetration of the vanes and blades into the products, so that by using circles of any diameter (FIG. 1; 1, 2, 3) and straight lines (4, 5) it is possible to give the vanes and blades the desired material thickness. The camber can also be reversed and can be positive or negative.

16. The method for designing, constructing and fabricating a turbine-propeller-jet (THR) wheel according to claim 3, wherein:
the whole wheel including the washers (FIG. 4, R1 R2 R3) is constructed using the five-parameter principle in its entirety and makes it possible to obtain, by means of infinitely small circle values, the sharp edges required for the penetration of the vanes and blades into the products, so that by using circles of any diameter (FIG. 1; 1, 2, 3) and straight lines (4, 5) it is possible to give the vanes and blades the desired material thickness. The camber can also be reversed and can be positive or negative.

17. The method for designing, constructing and fabricating a turbine-propeller-jet (THR) wheel according to claim 4, wherein:
the whole wheel including the washers (FIG. 4, R1 R2 R3) is constructed using the five-parameter principle in its entirety and makes it possible to obtain, by means of infinitely small circle values, the sharp edges required for the penetration of the vanes and blades into the products, so that by using circles of any diameter (FIG. 1; 1, 2, 3) and straight lines (4, 5) it is possible to give the vanes and blades the desired material thickness. The camber can also be reversed and can be positive or negative.

18. The method for designing, constructing and fabricating a turbine-propeller-jet (THR) wheel according to claim 5, wherein:
the whole wheel including the washers (FIG. 4, R1 R2 R3) is constructed using the five-parameter principle in its entirety and makes it possible to obtain, by means of infinitely small circle values, the sharp edges required for the penetration of the vanes and blades into the products, so that by using circles of any diameter (FIG. 1; 1, 2, 3) and straight lines (4, 5) it is possible to give the vanes and blades the desired material thickness. The camber can also be reversed and can be positive or negative.

19. The method for designing, constructing and fabricating a turbine-propeller-jet (THR) wheel according to claim 6, wherein:
the whole wheel including the washers (FIG. 4, R1 R2 R3) is constructed using the five-parameter principle in its entirety and makes it possible to obtain, by means of infinitely small circle values, the sharp edges required for the penetration of the vanes and blades into the products, so that by using circles of any diameter (FIG. 1; 1, 2, 3) and straight lines (4, 5) it is possible to give the vanes and blades the desired material thickness. The camber can also be reversed and can be positive or negative.

20. The method for designing, constructing and fabricating a turbine-propeller-jet (THR) wheel according to claim 7, wherein:
the whole wheel including the washers (FIG. 4, R1 R2 R3) is constructed using the five-parameter principle in its entirety and makes it possible to obtain, by means of infinitely small circle values, the sharp edges required for the penetration of the vanes and blades into the products, so that by using circles of any diameter (FIG. 1; 1, 2, 3) and straight lines (4, 5) it is possible to give the vanes and blades the desired material thickness. The camber can also be reversed and can be positive or negative.
